(19) United States
(12) Patent Application Publication
(10) Pub. No.: US 2017/0187215 A1
(43) Pub. Date: Jun. 29, 2017

(54) CHARGING DEVICE

(71) Applicant: NTN CORPORATION, Osaka (JP)

(72) Inventors: Hiroyuki NODA, Kuwana (JP); Masatoshi Mizutani, Kuwana (JP); Natsuhiko Mori, Kuwana (JP)

(73) Assignee: NTN CORPORATION, Osaka (JP)

(21) Appl. No.: 15/454,624

(22) Filed: Mar. 9, 2017

Related U.S. Application Data
(63) Continuation of application No. PCT/JP2015/075564, filed on Sep. 9, 2015.

(30) Foreign Application Priority Data
Sep. 18, 2014 (JP) 2014-189665

(51) Int. Cl. H02J 7/00; H02M 1/42; H01M 10/44

(52) U.S. Cl. CPC H02J 7/0052; H01M 10/44; H02M 1/4208; H02J 7/0047; H02J 2007/0059; H02J 2007/005

(57) ABSTRACT

A charging device includes a rectifier circuit that rectifies an alternating current of an AC power supply, and outputs the rectified alternating current as a pulsating current; power factor correction unit that enhances a power factor of the pulsating current outputted from the rectifier circuit; and an output circuit. The output circuit has an output terminal connecting to a charging terminal of a charging target device, and outputs a power-factor-corrected pulsating current outputted from the power factor correction unit, without performing voltage smoothing. The charging device further includes charging level detection unit that monitors a terminal voltage of a battery of the charging target device, and detects a charging level of the battery based on a fluctuating range of a ripple voltage, in the terminal voltage, generated by the pulsating current.

### CROSS REFERENCE TO THE RELATED APPLICATION

This application is a continuation application, under 35 U.S.C. §111(a), of international application No. PCT/JP2015/075564, filed Sep. 9, 2015, which claims priority to Japanese patent application No. 2014-189665, filed Sep. 18, 2014, the disclosure of which are incorporated by reference in their entirety into this application.

### BACKGROUND OF THE INVENTION

(Field of the Invention)

The present invention relates to a charging device that is used for, for example, quick charging of various charging target devices, such as an electric vehicle, a smart phone, a rechargeable dry battery, and a DIY power tool, each of which includes a rechargeable battery.

(Description of Related Art)

Conventionally, a rectified and smoothed DC power has been used to charge a battery, and an electric power storage state such as a fully charged state of the battery has been checked by checking the terminal voltage of the battery. As a device that is designed for research and experimental applications for measuring a very low resistance value such as an internal resistance of a battery, a battery tester/internal resistance measuring instrument that uses an AC four-terminal method is commercially available (Non-Patent Document 1).

### RELATED DOCUMENT

### Non-Patent Document

[Non-Patent Document 1] Battery tester/internal resistance measuring instrument using AC four-terminal method (Tokyo Devices IW7807), Tokyo Devices, http://tokyodevices.jp/categories/battery-testers (retrieved on Jun. 13, 2014)

### SUMMARY OF THE INVENTION

The conventional charging devices use a rectified and smoothed DC power as described above. However, it has been found that, even if a pulsating current that has been rectified without being smoothed, is connected, as it is, to a battery to charge the battery, the problem of reduced lifetime of the battery does not arise. It has been also found that, by improving detectors for a charging level, charging with a pulsating current is rather advantageous in the detection of the charging level.

That is, with the conventional methods for checking the electric power storage state from the terminal voltage of the battery, it is difficult to know an accurate electric power storage state. Accordingly, overcharge occurs especially during quick charging, and a problem may arise that a lifetime of the battery is shortened.

Therefore, the inventors of the present invention have paid attention to the proportional relationship between the internal resistance and the charging level of a battery, and considered detecting the charging level by detecting the internal resistance. The internal resistance of the battery can be detected with high precision by using an internal resistance measuring instrument. As to measurement of the internal resistance, the conventional internal resistance measuring instruments are devices intended for research and experimental applications, and are expensive and it is difficult to use the instruments for general purposes. Moreover, a measured value varies due to, for example, a resistance value being varied depending on how the terminal is placed, and it is therefore difficult for ordinary people to perform accurate measurement with the instruments.

In contrast, it has been found that, when charging is performed with a pulsating current, the charging level is detected based on the fluctuating range of a ripple voltage, in a terminal voltage of the battery, generated by the pulsating current.

As such, charging with a pulsating current is more advantageous in detecting the charging level, and also in preventing overcharge so as to make the battery lifetime long.

However, a pulsating current that is merely rectified from an alternating current of a commercial power supply or the like has a current waveform in the form of pulses having narrow widths although having a voltage waveform in the form of a sine wave. The electric power that is charged is a product of a current and a voltage. Accordingly, when the current value between the pulses of the current waveform is zero, the electric power is also zero, and a problem arises that efficiency for the charging is low.

An object of the present invention is to provide, for solving the above-described problem, a charging device having an improved charging efficiency while performing charging with a pulsating current that is advantageous in detection of a charging level.

A charging device according to the present invention includes: a rectifier circuit 2 configured to rectify an alternating current from an AC power supply 1 to output a pulsating current; a power factor correction unit 15 configured to enhance a power factor of the pulsating current outputted from the rectifier circuit 2; and an output circuit 6, having an output terminal 5 that connects to a charging terminal of a charging target device 3, configured to output a power-factor-corrected pulsating current that is outputted from the power factor correction unit 15, without performing voltage smoothing.

According to this configuration, the power factor correction unit 15 is provided, and the power factor of the pulsating current outputted from the rectifier circuit 2 is thus enhanced. Since charging is performed with the power-factor-corrected pulsating current, charging can be efficiently performed while charging is performed with a pulsating current. Since charging is performed with a pulsating current, the charging level can be accurately detected, and overcharge can be prevented to make the battery lifetime long, as described below. That is, charging with a pulsating current causes a ripple voltage in a terminal voltage of the battery. The fluctuating range, that is, the amplitude of the ripple voltage is proportional to the internal resistance of the battery. In addition, the internal resistance of the battery decreases as charging progresses. Accordingly, by measuring the fluctuating range of the terminal voltage of the battery, the charging level of the battery can be accurately detected. This makes it possible to detect a fully charged state with high precision, and avoid overcharge during quick charging or the like, thereby preventing reduction in the lifetime of the battery. Although charging is performed with a pulsating current, reduction in the lifetime of the battery as in the case of overcharge does not occur even if the voltage fluctuates.

In one embodiment of the present invention, the power factor correction unit 15 may be configured to shape a current waveform of the pulsating current outputted from the rectifier circuit into a rectangular shape, and to narrow a width between wave crests to obtain the power-factor-corrected pulsating current. With this configuration, by shaping the current waveform of the pulsating current into a rectangular shape and narrowing the width between wave crests, the power factor of the pulsating current is enhanced, so that the electric power applied to the battery is increased.

In one embodiment of the present invention, the charging device may further include a charging level detection unit 7 configured to monitor a terminal voltage of a battery 4 of the charging target device 3 to detect a charging level of the battery 4 based on a fluctuating range of a ripple voltage in the terminal voltage generated by the pulsating current. As described above, when charging is performed with a pulsating current that has not been subjected to voltage smoothing after rectification, a ripple voltage is generated in the terminal voltage of the battery 4. The fluctuating range, that is, the amplitude of the ripple voltage is proportional to the internal resistance of the battery 4. In addition, the internal resistance of the battery 4 decreases as charging progresses. Accordingly, by measuring the fluctuating range of the terminal voltage of the battery 4 by the charging level detection unit 7, the charging level of the battery 4 can be accurately detected. This makes it possible to detect a fully charged state with high precision, and prevent overcharge during quick charging or the like, thereby preventing reduction in the lifetime of the battery 4.

Here, the “ripple voltage” refers to a voltage that is superimposed on a direct current component and fluctuates periodically.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a circuit diagram of a charging device according to one embodiment of the present invention;

FIG. 2 is an explanatory diagram schematically showing examples of waveforms of voltage, current, and electric power in the charging device before and after correction performed by power factor correction unit;

FIG. 3 is a circuit diagram of a charging device according to another embodiment of the present invention; and

FIG. 4 is an electric circuit diagram showing an example of the power factor correction unit.

### DESCRIPTION OF EMBODIMENTS

One embodiment of the present invention will be described in conjunction with the drawings. A charging device according to the present embodiment includes: a rectifier circuit 2 configured to rectify an alternating current from an AC power supply 1 to output a pulsating current; a power factor correction unit 15 configured to enhance a power factor of the pulsating current that is outputted from the rectifier circuit 2; and an output circuit 6, having output terminals 5 that connect to charging terminals (not shown) of a charging target device 3, configured to output a power-factor-corrected pulsating current that is outputted from the power factor correction unit 15, without performing voltage smoothing. The charging device further includes charging level detection unit 7 configured to monitor the terminal voltage of a battery 4 of the charging target device 3 to detect a charging level of the battery 4 based on the fluctuating range of a ripple voltage in the terminal voltage, generated by the pulsating current. The charging device further includes a charge stopping unit 11 and a charging level notification unit 13.

The AC power supply 1 is, for example, a single-phase 100V or 200V AC commercial power supply. Input terminals 8 such as a plug that is inserted into an outlet (not shown) in the wiring of the AC power supply 1 are provided upstream of the rectifier circuit 2. The rectifier circuit 2 is a full-wave rectifier circuit, and includes a bridge circuit using semiconductor switching elements 2a, and the like. The rectifier circuit 2 may be a half-wave rectifier circuit.

The charging target device 3 may be any device including a battery 4 which is rechargeable. Examples thereof include an electric vehicle, a smart phone, a personal computer, a DIY power tool and a charging socket for a rechargeable dry battery.

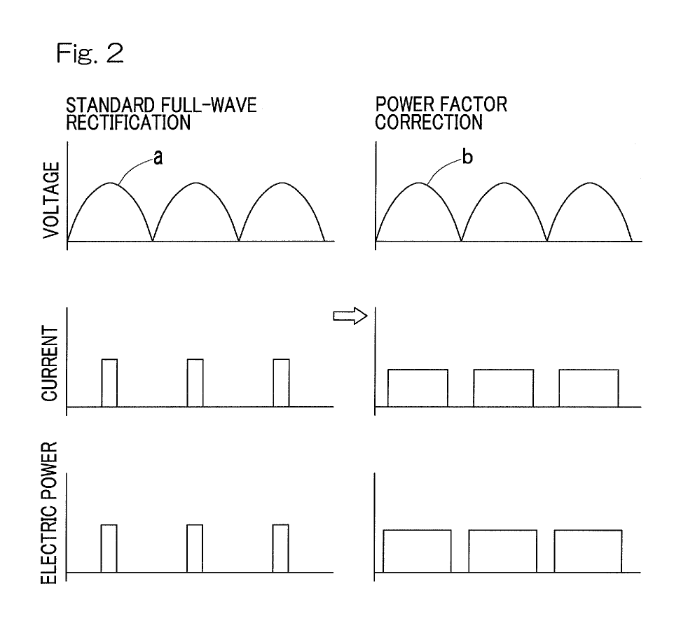

The power factor correction unit 15 includes a power factor correction circuit or the like. The power factor correction circuit refers to a circuit configured to cause the power factor of a power supply to approach 1, and is often called a PFC (Power Factor Correction) circuit. The power factor can be determined as: power factor=cos □, where □ represents a phase difference between the voltage and the current of an AC power. As the power factor correction unit 15, a power factor correction circuit of a flyback type may be used, for example. In this embodiment, specifically, as a process for correcting the power factor, the power factor correction unit 15 shapes the current waveform of the inputted pulsating current a into a rectangular shape, and narrows the width between wave crests to obtain the power-factor-corrected pulsating current b, as shown in FIG. 2.

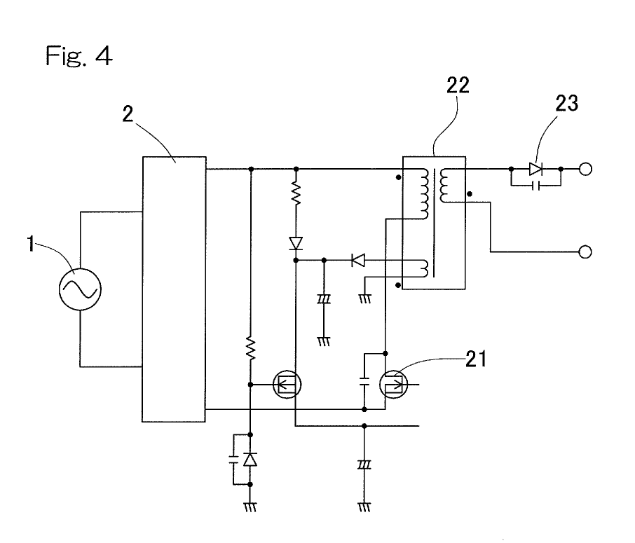

FIG. 4 shows an example of a circuit of the power factor correction unit 15. Briefly, when a switching element 21 is turned on, a current flows to a primary side of a transformer 22, and the energy is stored. When the switching element 21 is turned off, the stored energy is outputted from a secondary side of the transformer 22 through a diode 23.

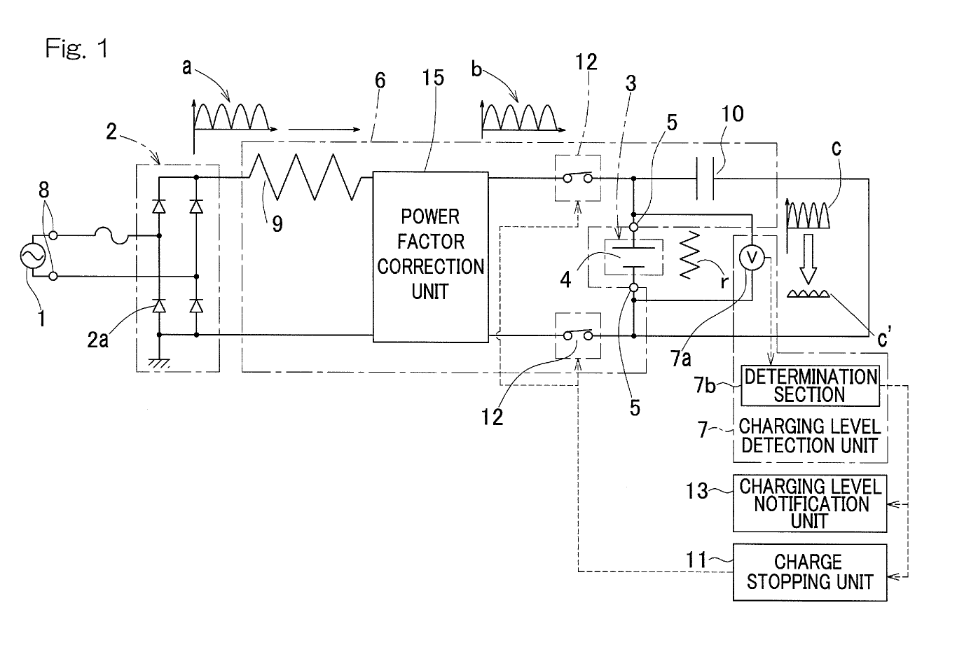

In FIG. 1, the output circuit 6 may have any configuration that applies, to the output terminals 5, the power-factor-corrected pulsating current outputted from the power factor correction unit 15. In the illustrated example, a current limiting resistor 9 is provided on a downstream side of the rectifier circuit 2, and a capacitor 10 for preventing the passage of a DC voltage of the battery is connected in parallel with the positive and negative output terminals 5, 5. An anti-backflow diode (not shown) may be provided on an upstream side of the output terminals 5 in the output circuit 6.

In this example, the charging level detection unit 7 includes a voltage detection section 7a having a voltmeter connected between the positive and negative terminals 5, 5 of the output circuit 6, and a determination section 7b. The determination section 7b is configured to determine that charging is completed when the fluctuating range of the terminal voltage detected by the voltage detection section 7a is less than or equal to a set fluctuating range, or less than the set fluctuating range. The set fluctuating range may be the fluctuating range of the ripple voltage in the case of a fully charged state being reached. However, the set fluctuating range may not necessarily represent a value corresponding to a fully charged state, and may represent a value that is set so as to provide a margin for allowing remaining charging. For example, in the case of the battery for an electric vehicle, when a margin for allowing remaining charging is provided, room for charging with a regenerative brake is given. Although the set fluctuating range is set according to, for example, the type of the battery 4 to be charged, the set fluctuating range may be switchable by using a mode switch (not shown) or the like so as to support a plurality of types of batteries 4.

Specifically, the voltage detection section 7a may be, for example, a digital voltmeter including an operational amplifier, a filter, a logic circuit, or the like, and is configured to monitor and detect the terminal voltage, and output the detected voltage value in the form of a given signal. The determination section 7b includes a hardware circuit or a software function that: uses, for example, a LUT (Look Up Table) implemented by software or hardware, or a predetermined transform function or comparison function stored in a library of software or equivalent hardware; receives an input of the fluctuating range of the terminal voltage and an input of the set fluctuating range; and can outputs a flag, that is, the determination signal indicating that charging is completed, as a result of comparison between the fluctuating range of the terminal voltage and the set fluctuating range. The software is stored in an ROM (Read Only Memory), and is read out and executed by a processor so as to drive an electric signal to the outside, for example.

The charge stopping unit 11 is configured to stop charging when the charging level detection unit determines that charging is completed, and stops charging, for example, by opening an opening/closing switch 12 provided in the output circuit 6. The opening/closing switch 12 may be a semiconductor switching element, or may be a switch having a contact, such as a relay. The charge stopping unit 11 is, for example, a hardware circuit including a drive circuit configured to receive an input of a determination signal indicating that charging is completed, from the charging level detection unit 7, and output a signal for opening or closing the opening/closing switch 12.

The charging level notification unit 13 is configured to notify a person of the charging level detected by the charging level detection unit 7, and includes, for example, a liquid crystal panel or a notification lamp. The charging level notification unit 13 may be configured to make notification of the charging level in a stepwise manner, for example, by turning the lamp on or off or causing the lamp to blink, or may be configured to display a percentage, an index, a graph, or the like on a screen such as a liquid crystal screen.

According to the charging device having the above-described configuration, the pulsating current a that has been full-wave rectified by the rectifier circuit 2 is power-factor-corrected, by the power factor correction unit 15, into a pulsating current b having a current waveform shaped into a rectangular shape as shown in FIG. 2. The output circuit 6 performs charging with the pulsating current b that has not been smoothed after being power-factor-corrected.

Referring to FIG. 2, the pulsating current a that has been full-wave rectified by the rectifier circuit 2 has a voltage waveform in the form of a sine wave as shown in the top row in the left column in FIG. 2, but has a current waveform in the form of pulses having narrow widths with large intervals between the pulses as shown in the middle row in the left column. While the current value of the current waveform is zero, the electric power is also zero. Therefore, as shown in the bottom row in the left column, the electric power waveform is in the form of pulses having narrow width, similarly to the current waveform. Therefore, if the pulsating current a is used as it is for the charging, charging efficiency is low. However, in the present embodiment, as shown in the right column in FIG. 2, the current waveform of the inputted pulsating current a is shaped into a rectangular shape and the width between wave crests is narrowed by the power factor correction unit 15. Consequently, the power factor is corrected, so that the electric power waveform becomes a wide rectangular waveform and the width between adjacent pulses in the current waveform is narrowed. Accordingly, by performing charging with the power-factor-corrected pulsating current b, charging can be performed in a short time period as efficiently as possible although the pulsating current is used.

Although the power factor correction is performed as described above, since the pulsating current is used, a ripple voltage c corresponding to the pulsating current b serving as a charging voltage is generated in the terminal voltage of the battery 4. The fluctuating range, that is, the amplitude of the ripple voltage c is proportional to an internal resistance r of the battery 4. The internal resistance r of the battery 4 decreases as charging progresses. Accordingly, as charging progresses, the ripple voltage c decreases as indicated by a waveform denoted by reference character “c”, and the charging level of the battery 4 can be accurately detected by the fluctuating range of the terminal voltage of the battery 4 being measured by the charging level detection unit 7.

The charging level detected by the charging level detection unit 7 is displayed by the charging level notification unit 13 in a stepwise manner or in a percentage or the like. When the fluctuating range of the ripple voltage c detected by the charging level detection unit 7 is less than or equal to the set fluctuating range, or less than the set fluctuating range, the charging level detection unit 7 determines that charging is completed. In response to this determination, the charge stopping unit 11 opens the opening/closing switch 12 so as to stop charging.

Although many charging target devices 3 such as a smart phone are each left connected to a charging device, in a case where the charge stopping unit 11 is provided, overcharge is prevented and reduction in the lifetime of the battery 4 can be prevented, without particularly requiring a manual operation.

As such, with the charging device having this configuration, since charging is performed with a pulsating current that has not been smoothed after rectification, a stage of charge such as a fully charged state can be accurately detected and overcharge can be prevented, thereby preventing reduction in the lifetime of the battery. Charging is performed not with a pulsating current that has been outputted simply by rectification, but with a pulsating current that has been power-factor-corrected after rectification. Accordingly, charging can be efficiently performed in a short time period and quick charging can be also supported.

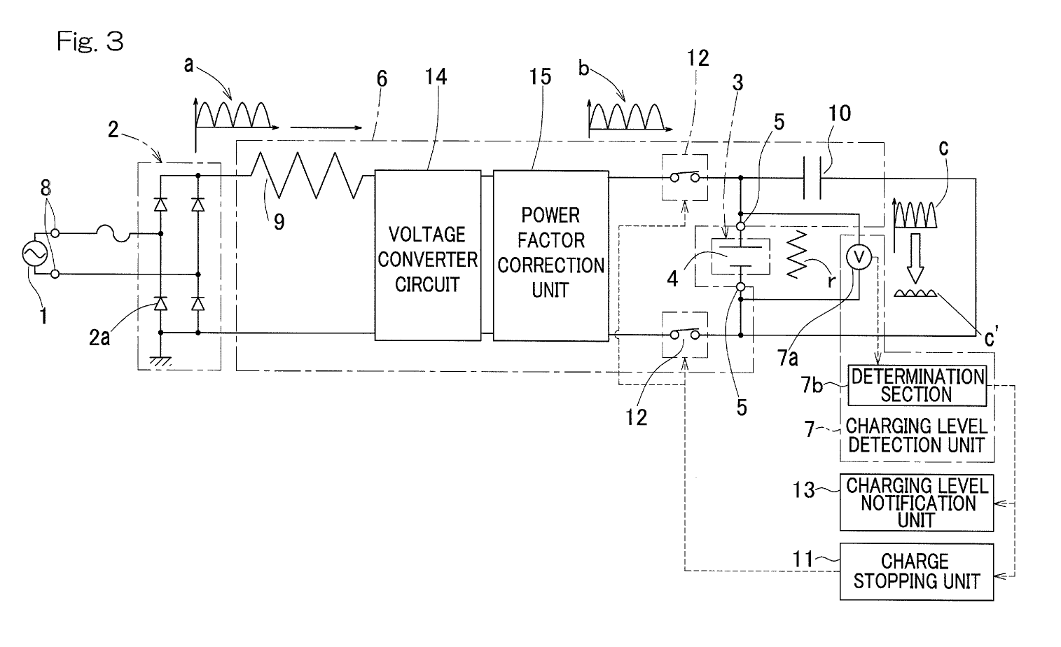

FIG. 3 shows another embodiment of the present invention. In this example, a voltage converter circuit 14 configured to convert a voltage is provided in the first embodiment shown in FIG. 1. The voltage converter circuit 14 may be, for example, a hardware circuit that includes a regulator, a semiconductor element, and the like. Although the voltage converter circuit 14 is provided on a downstream side of the rectifier circuit 2 in the illustrated example, the voltage converter circuit 14 may be provided on an upstream side of the rectifier circuit 2. The other components are the same as in the first embodiment.

Since the voltage of the AC power supply 1 and the voltage of the battery 4 are significantly different in some cases, the voltage converter circuit 14 is provided so as to allow charging to be performed after converting the output voltage of the rectifier circuit 2 on the input side such that the charging voltage on the output side on which the battery 4 is connected, is converted to a voltage suitable for the charging, thereby advantageously performing the charging. In this case, since the charging device performs charging with a pulsating current, it is preferable that the charging voltage applied to the charging terminals of the battery 4 is set to be higher than a voltage in the case of charging being performed with a normal smoothed direct current. This makes it possible to avoid increase in the charging time for a direct current resulting from charging with a pulsating current.

Although the present invention has been fully described in connection with the preferred embodiments thereof with reference to the accompanying drawings, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

1 . . . AC power supply

2 . . . Rectifier circuit

3 . . . Charging target device

4 . . . Battery

5 . . . Output terminal

6 . . . Output circuit

7 . . . Charging level detection unit

11 . . . Charge stopping unit

13 . . . Charging level notification unit

14 . . . Voltage converter circuit

15 . . . Power factor correction unit

What is claimed is:

1. A charging device comprising:
a rectifier circuit configured to rectify an alternating current of an AC power supply, and output the rectified alternating current as a pulsating current;
a power factor correction unit configured to enhance a power factor of the pulsating current outputted from the rectifier circuit; and
an output circuit, having an output terminal that connects to a charging terminal of a charging target device, configured to output a power-factor-corrected pulsating current outputted from the power factor correction unit, without performing voltage smoothing.

2. The charging device as claimed in claim 1, wherein the power factor correction unit is configured to shape a current waveform of the pulsating current outputted from the rectifier circuit into a rectangular shape, and to narrow a width between wave crests to obtain the power-factor-corrected pulsating current.

3. The charging device as claimed in claim 1, further comprising a charging level detection unit configured to monitor a terminal voltage of a battery of the charging target device to detect a charging level of the battery based on a fluctuating range of a ripple voltage in the terminal voltage generated by the pulsating current.
